(19) United States
(12) Patent Application Publication
(10) Pub. No.: US 2009/0207047 A1
(43) Pub. Date: Aug. 20, 2009

(54) Wireless Landing Gear Verification System

(75) Inventor: W. Anthony Ross, III, Plano, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/034,302

(22) Filed: Feb. 20, 2008

(51) Int. Cl. G08B 21/00

(52) U.S. Cl. 340/960

(57) ABSTRACT

According to one embodiment, a verification system for an aircraft includes a cockpit instrument in communication with a wireless communication circuit. The wireless communication circuit is coupled to a landing gear member and operable to determine a position of the landing gear member and transmit the position to the cockpit instrument using a wireless signal.

### TECHNICAL FIELD OF THE DISCLOSURE

This disclosure relates generally to landing gear for aircraft, and more particularly, to a wireless landing gear verification system and method of operating the same.

### BACKGROUND OF THE DISCLOSURE

Landing gear that retract into the body of an aircraft during flight are commonly referred to as retractable landing gear. Placement of the landing gear within the body of the aircraft generally enhances performance of the aircraft by reducing drag caused by turbulence as the aircraft moves through the air. This retractable landing gear may be selectively movable from an extended position for movement over the surface of the Earth to a retractable position during flight.

### SUMMARY OF THE DISCLOSURE

According to one embodiment, a verification system for an aircraft includes a cockpit instrument in communication with a wireless communication circuit. The wireless communication circuit is coupled to a landing gear member and operable to determine a position of the landing gear member and transmit the position to the cockpit instrument using a wireless signal.

Some embodiments of the disclosure may provide numerous technical advantages. Some embodiments may benefit from some, none, or all of these advantages. For example, one embodiment of the wireless landing gear verification system may provide an advantage in that various failure modes affecting wired landing gear verification systems may not affect operation of the wireless landing gear verification system. The wireless landing gear verification system may be used in conjunction with other wired landing gear verification systems such that a failure mode affecting the wired landing gear verification system may not necessarily affect operation of the wireless landing gear verification system. Thus, the wireless landing gear verification system may provide enhanced reliability for retractable landing gear configured on an aircraft.

Other technical advantages may be readily ascertained by one of ordinary skill in the art.

### BRIEF DESCRIPTION OF THE DRAWINGS

A more complete understanding of embodiments of the disclosure will be apparent from the detailed description taken in conjunction with the accompanying drawings in which:

FIG. 1 is a front elevational view of one embodiment of a landing gear verification system configured on an aircraft;

FIG. 2 is a bottom view of another embodiment of a landing gear verification system configured on another aircraft; and

FIG. 3 is a flowchart showing a series of actions that may be performed by the landing gear verification system of FIGS. 1 or 2.

### DETAILED DESCRIPTION OF EXAMPLE EMBODIMENTS OF THE DISCLOSURE

To enable selective movement of landing gear from the extended to the retracted position, various types of physical mechanisms have been developed. These physical mechanisms however, may be prone to failure due to the relatively large weight of the aircraft and/or use on runways with uneven or bumpy surfaces. Known systems using wired communication for indicating the position of the landing gear to the pilot are known. These known systems however, may also be prone to failure due to cabling failure within the aircraft or damage caused by use in a combat environment.

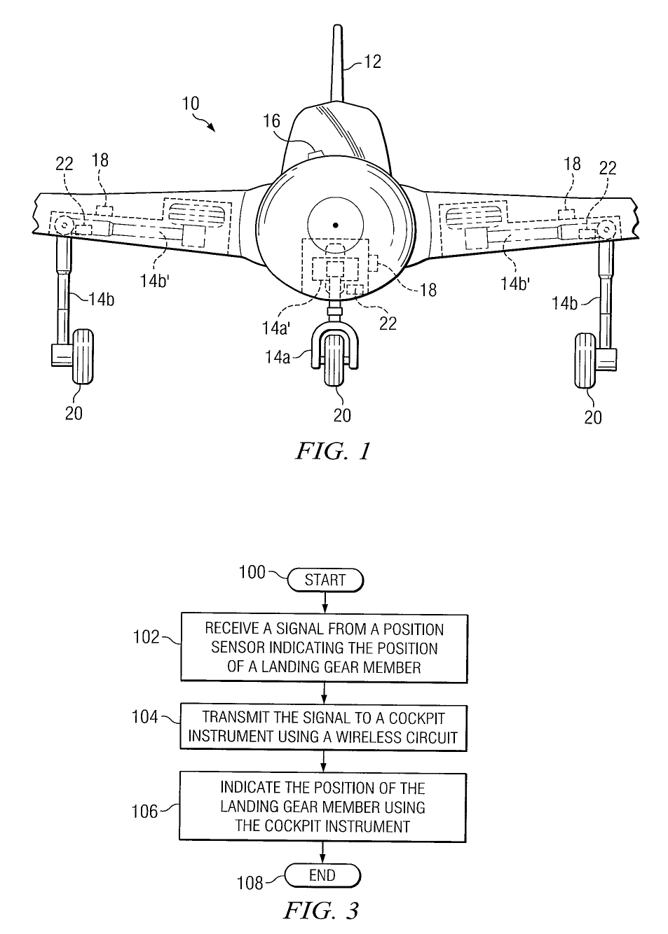

FIG. 1 shows one embodiment of a wireless landing gear verification system 10 according to the present disclosure that may provide a solution to these needs as well as other needs. Wireless landing gear verification system 10 is configured on an aircraft 12 having retractable landing gear that may include a number of landing gear members 14 for support of the aircraft while on the ground. Retractable landing gear may be selectively movable from an extended position 14a and 14b for movement over the ground to a retracted position 14a′ and 14b′ during flight. According to the teachings of the present disclosure, wireless landing gear verification system 10 may be operable to provide an indication of the position of at least one of the landing gear members 14 to a cockpit instrument 16 using a wireless communication circuit 18.

Certain embodiments of a wireless landing gear verification system 10 incorporating wireless signaling may provide an advantage in that failure modes affecting wired landing gear verification systems may not affect operation of the wireless landing gear verification system 10. Multiple landing gear verification systems may be redundantly configured on an aircraft to increase the reliability of the landing gear system. If one of the wired landing gear verification systems should fail, one of the other wired landing gear verification systems would be used to provide indication of the position of the landing gear members 14. However, failure modes that cause one wired landing gear verification systems to fail may also cause other redundant wired landing gear verification systems to fail as well. Thus, the wireless landing gear verification system 10 may provide enhanced reliability over known wired landing gear verification systems in that failure modes affecting wired communication between the landing gear members 14 and cockpit instrumentation may not affect the wireless landing gear verification system 10 in some embodiments.

Landing gear members 14 may refer to any type of landing gear member used to support the aircraft 12 while on the ground. Landing gear members 14 configured on the nose portion of the aircraft may be referred to as a nose landing gear member 14a. Landing gear members 14 configured on the wing portion of the aircraft may be referred to as wing landing gear members 14b. In the particular embodiment shown, landing gear members 14 include wheels 20 for movement over the ground, however it should be appreciated that landing gear members 14 may include other ground support mechanisms, such as, for example, skids for support over snow, or pontoons for support on water.

Each wireless communication circuit 18 may be operable to receive a signal indicative of its respective landing gear member 14 using a position sensor 22 coupled to its respective wireless communication circuit 18. In one embodiment, cockpit instrument 16 is operable to provide a synchronized indication when each of the landing gear members 14 are in the extended position 14a and 14b or retracted position 14a′ and 14b′. That is, the cockpit instrument 16 may be operable to provide a single indication that becomes active when each of the landing gear members 14 are securely in the extended or retracted position. In this manner, a pilot of the aircraft 12 may use a relatively simple indication to obtain a relatively high level of confidence that the landing gear members 14 are in the desired position.

Wireless communication circuits 18 may communicate with cockpit instrument 16 using any suitable wireless protocol. In one embodiment, wireless communication circuits 18 may communicate with the cockpit instrument 16 using a Bluetooth protocol. The Bluetooth protocol provides an established, generally robust mechanism for wireless communication using radio frequency (RF) carrier waves. In another embodiment, each communication circuit 18 may be configured in a network so that position indication may be easily coordinated among multiple communication circuits 18. Multiple communication circuits 18 incorporating the Bluetooth protocol may be configured in a Piconet network.

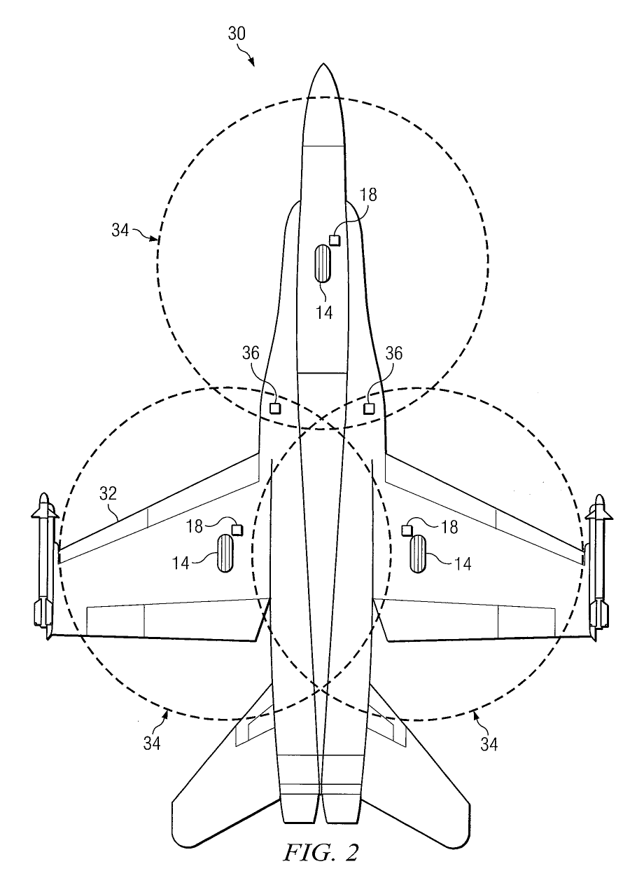

FIG. 2 shows a bottom view of another aircraft 32 incorporating another embodiment of a wireless landing gear verification systems 30. Each of the wireless communication circuits 18 has an effective range 34 at which relatively reliable communication with one another may occur. In this particular embodiment, the landing gear members 14 are spaced apart from one another at a distance that exceeds the effective range 34 of the wireless communication circuits 18. Thus in one embodiment, one or more intermediary nodes 36 may be included to relay messages from one wireless communication circuit 18 configured on one landing gear member 14 to another wireless communication circuit 18 configured on another landing gear member 14. In another embodiment, each of the intermediary nodes 36 may enable signaling from one wireless communication circuit 18 to another using a Scatternet network. When configured in a Scatternet network, the intermediary nodes 36 function as a slave device to one wireless communication circuit 18 and a gateway to another wireless communication circuit 18. Thus, position indicating signals from one wireless communication circuit 18 may be effectively propagated to other wireless communication circuits 18 and to the cockpit instrument 16.

FIG. 3 shows a series of actions that may be performed by the wireless landing gear verification system 10 or 30 to verify the position of the landing gear members 14 configured on the aircraft 12 or 32. In act 100, the process is initiated. The process may be initiated by applying electrical power to each of the wireless communication circuits 18 and to the cockpit instrument 16. In one embodiment, electrical power is applied to the wireless communication circuits 18 and cockpit instrument 16 whenever the aircraft systems are active. In this manner, the cockpit instrument 16 may continually indicate the current position of the landing gear members 14 throughout operation of the aircraft 12 or 32.

In act 102, the wireless communication circuit 18 may receive a signal from its respective landing gear member 14 to which it is coupled. In one embodiment, the wireless communication circuit 18 may receive the signal from a position sensor 22 mechanically coupled to the landing gear member 14. In another embodiment, a number of wireless communication circuits 18 may be provided to receive the signal indicating the position of each of a corresponding number of landing gear members 14 configured on the aircraft 12 or 32.

In act 104, the wireless communication circuit 18 may transmit a wireless signal to the cockpit instrument that includes information regarding the position of the landing gear member 14. In one embodiment, the wireless communication circuit 18 may transmit the wireless signal using a Bluetooth protocol. In another embodiment, wireless communication circuits 18 may communicate with one another using an intermediary node 36.

In act 106, the cockpit instrument 16 may indicate the position of the landing gear members 14 to the pilot. In one embodiment, the cockpit instrument 16 may provide a single extended or retracted indication when all of the wireless communication circuits 18 are in the extended or retracted position, respectively.

The process described above continues throughout operation of the aircraft 12 or 32 to provide indication to the pilot of the position of the landing gear members 14. When operation of the wireless landing gear verification system 10 or 30 is no longer needed or desired, electrical power may be removed from the wireless communication circuits 18 and cockpit instrument 16 in which the process ends in act 108.

A wireless landing gear verification system 10 and 30 has been described that may enable indication of the position of retractable landing gear members 14 to the pilot of an aircraft 12 or 32. The wireless landing gear verification system 10 and 30 may be implemented as a primary indication of the landing gear's position or may provide secondary indication for an existing landing gear indication system for enhancing overall reliability of the aircraft's landing gear indication system. Thus, wireless signaling between landing gear members 14 and cockpit instrument 16 may provide enhanced reliability by being generally immune to failure modes that may cause wired landing gear verification systems to fail.

Although the present disclosure has been described with several embodiments, a myriad of changes, variations, alterations, transformations, and modifications may be suggested to one skilled in the art, and it is intended that the present disclosure encompass such changes, variations, alterations, transformation, and modifications as they fall within the scope of the appended claims.

What is claimed is:

1. A verification system for an aircraft comprising:
a cockpit instrument for indicating an extended position or a contracted position of a plurality of landing gear members configured on the aircraft;
a plurality of Bluetooth communication circuits that are each associated with a corresponding one of the plurality of landing gear members and coupled to one of a plurality of position sensors, the plurality of Bluetooth communication circuits being configured together in a Piconet network, each of the plurality of Bluetooth communication circuits being operable to:
receive a signal indicative of the extended position or the contracted position from the one of the plurality of position sensors coupled to each of the plurality of landing gear members; and
transmit the signal to the cockpit instrument using a wireless signal.

2. The verification system of claim 1, further comprising an intermediary node coupled between one Bluetooth communication circuit and another.

3. A verification system for an aircraft comprising:
a cockpit instrument for indicating the position of at least one landing gear member of the aircraft;
at least one wireless communication circuit coupled to at least one position sensor, the at least one wireless communication circuit being operable to:
receive a signal indicative of the position from the at least one position sensor coupled to the at least one landing gear member; and
transmit the signal to the cockpit instrument using a wireless signal.

4. The verification system of claim 3, wherein the at least one wireless communication circuit is further operable to transmit the signal to the cockpit instrument using a Bluetooth protocol.

5. The verification system of claim 3, wherein the aircraft comprises a plurality of landing gear members, the at least one wireless communication circuit further comprising one wireless communication circuit for each landing gear member of the plurality of landing gear members.

6. The verification system of claim 5, wherein the plurality of wireless communication circuits are arranged in a communication network with one another.

7. The verification system of claim 6, wherein the communication network is a Piconet network.

8. The verification system of claim 6, wherein the communication network is a Scatternet network.

9. The verification system of claim 8, further comprising an intermediary node coupled between one wireless communication circuit and another.

10. The verification system of claim 5, wherein the cockpit instrument is operable to provide a synchronized indication when each of the plurality of landing gear members are in an extended position.

11. The verification system of claim 5, wherein the cockpit instrument is operable to provide a synchronized indication when each of the plurality of landing gear members are in a retracted position.

12. A method comprising:
generating a signal indicative of a position of at least one landing gear member of an aircraft;
transmitting, using a communication circuit, the signal to a cockpit instrument using a wireless signal; and
indicating the position, using the signal, on the cockpit instrument.

13. The method of claim 12, wherein transmitting the signal to the cockpit instrument further comprises transmitting the signal to the cockpit instrument using a Bluetooth protocol.

14. The method of claim 12, wherein generating a signal indicative of the position of at least one landing gear member further comprises generating a plurality of signals indicative of a plurality of landing gear members using a corresponding plurality of communication circuits.

15. The method of claim 12, wherein transmitting the signal to the cockpit instrument further comprises transmitting the signal to the cockpit instrument using a communication network.

16. The method of claim 15, wherein transmitting the signal to the cockpit instrument using a communication network further comprises transmitting the signal to the cockpit instrument using a Piconet network.

17. The method of claim 15, wherein transmitting the signal to the cockpit instrument using a communication network further comprises transmitting the signal to the cockpit instrument using a Scatternet network.

18. The method of claim 16, wherein transmitting the signal to the cockpit instrument further comprises transmitting the signal to the cockpit instrument through an intermediary node.

19. The method of claim 15, wherein indicating the position further comprises indicating a synchronized indication when each of the plurality of landing gear members are in an extended position.

20. The method of claim 15, wherein indicating the position further comprises indicating a synchronized indication when each of the plurality of landing gear members are in a retracted position.
